(19) United States
(12) Patent Application Publication
(10) Pub. No.: US 2019/0331809 A1
(43) Pub. Date: Oct. 31, 2019

(54) PLASTIC SCINTILLATOR, DETECTOR, ASSOCIATED MANUFACTURING PROCESS AND SCINTILLATION MEASUREMENT PROCESS

(71) Applicant: COMMISSARIAT A L'ENERGIE ATOMIQUE ET AUX ENERGIES ALTERNATIVES, PARIS (FR)

(72) Inventors: Matthieu HAMEL, CHERBOURG-OCTEVILLE (FR); Guillaume BERTRAND, MEYRAS (FR); Fabien SGUERRA, SAINT-LAURENT DU VAR (FR)

(21) Appl. No.: 16/089,666

(22) PCT Filed: Mar. 28, 2017
(86) PCT No.: PCT/FR2017/050706

§ 371 Date: Sep. 28, 2018

(30) Foreign Application Priority Data
Apr. 1, 2016 (FR) 1652902

(51) Int. Cl. G01T 1/203; C09K 11/06; C08F 212/08

(52) U.S. Cl. CPC G01T 1/2033; C08F 212/08; C09K 11/06

(57) ABSTRACT

Material for plastic scintillation measurement comprising: —a polymeric matrix; —a primary fluorophore incorporated in the polymeric matrix and composed of N-(2-ethylhexyl)carbazole, the monomer form of the N-(2-ethylhexyl)carbazole being spontaneously in physicochemical equilibrium with the exciplex form; and, —a secondary fluorophore. A plastic scintillator can be manufactured in a simplified manner with the material of the invention, while having optimized properties for the plastic scintillation measurement. The invention also relates to the process for the manufacture of the material, to a part comprising the material and to the associated measurement device, and also to the process for measurement by plastic scintillation using the material.

### TECHNICAL FIELD

The present invention belongs to the field of the measurement of radioactivity by the plastic scintillation technique.

The invention more particularly relates to a material for the measurement by plastic scintillation and to its process of manufacture, to a part comprising the material and to its associated measurement device, and also to the process for measurement by plastic scintillation using the material.

### TECHNICAL BACKGROUND

The plastic scintillation measurement consists in determining the presence and/or the amount of one or more radioactive substances, among others in physics, geology, biology or medicine, for dating, environmental monitoring or control of the nonproliferation of nuclear arms.

In practice, the radioactive substance emitting ionizing radiation or an ionizing particle (alpha particle, electron, positron, photon, neutron, and the like) is exposed to a scintillating material known as “plastic scintillator” which converts the energy deposit resulting from the radiation/substance interaction into light radiation (“radioluminescent” radiation) which can be measured by a photon-electron converter having gain, such as, for example, a photomultiplier.

The plastic scintillator has been known since the middle of the XX^{th} century. It is described, for example, in the document “Principles and practice of plastic scintillator design, Radiat. Phys. Chem., 1993, Vol. 41, No. 1/2, 31-36” [1]. It is generally provided in the form of a polymeric matrix into which a primary fluorophore, indeed even a secondary fluorophore, is inserted.

The main role of the polymeric matrix is to be a support capable of receiving the energy of the ionizing radiation or of the ionizing particle. After recombination of the excited and/or ionized entities which are then formed, this energy is converted into radioluminescent radiation which is transferred to the primary fluorophore and optionally to the secondary fluorophore, which can modify the wavelength of the radiation emitted by the primary fluorophore in order to improve the detection thereof. The primary fluorophore and the secondary fluorophore are constituted of an aromatic molecule with fluorescent properties (molecule known as fluorophore) which makes possible the scintillation detection.

Such a plastic scintillator poses at least one of the following problems:
The difficulty in determining the composition of the complex mixture of primary and secondary fluorophores in order for its centroid of the radioluminescence radiation to lie optimally between 380 nm and 450 nm and/or for the Stokes shift to be as great as possible. The Stokes shift, expressed in cm⁻¹, is the difference between the wavenumber of the maximum of the absorption band and that of the maximum of the fluorescence emission spectrum. Among others, in order to obtain a good plastic scintillator with the satisfactory scintillation yield, the Stokes shift should be as great as possible, which means that the overlap between the absorption and emission spectra of the scintillator is reduced, indeed even zero, which prevents a loss of photons or their own absorption by the scintillator.
A transfer of the photons between the polymeric matrix, the primary fluorophore and the secondary fluorophore which is not optimum, among others because of a quenching phenomenon, which damages the sensitivity and the quality of the plastic scintillation measurement.
An aging of the plastic scintillator, among others by precipitation of the primary or secondary fluorophore, which affects the transparency to its own light and thus the fluorescence yield, which damages the plastic scintillation measurement.

In order to attempt to solve these problems, one of the routes for improvement consists in modifying the chemical or physicochemical characteristics of the plastic scintillator, as illustrated by the document “Current status on plastic scintillators modifications, Chem. Eur. J., 2014, 20, 15660-15685” [2]. For example, these modifications may relate to the chemical composition of the polymeric matrix or of the plastic scintillator (among others, to the concentration of the primary or secondary fluorophore in the polymeric matrix) or to the degree of crosslinking of the polymeric matrix.

Nevertheless, generally, the plastic scintillators of the state of the art still exhibit at least one of the problems set out above.

### DESCRIPTION OF THE INVENTION

One of the aims of the invention is thus to avoid or alleviate one or more of the disadvantages described above by providing a material using a specific carbazole derivative.

The present invention relates to a material for plastic scintillation measurement comprising (indeed even consisting of):
a polymeric matrix;
a primary fluorophore incorporated in the polymeric matrix and composed of N-(2-ethylhexyl)carbazole, the monomer form of the N-(2-ethylhexyl)carbazole being spontaneously in physicochemical equilibrium with the exciplex form; and,
a secondary fluorophore.

The material for the plastic scintillation measurement according to the invention is also denoted in the present description by the expression “plastic scintillator”. It is characterized among others by the incorporation of a specific molecule which is N-(2-ethylhexyl)carbazole, also known under the abbreviation “EHCz”, the general formula (I) of which is:

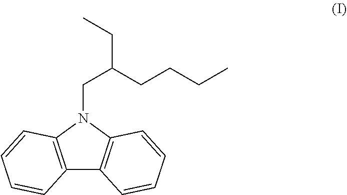

In contrast to the routes for improvement followed by the state of the art, the invention does not consist of the use of a new polymeric matrix, the addition of additive to the plastic scintillator or the development as primary fluorophore of new families of molecules (quantum dots, organometallic complexes, nanoparticles, and the like) in order to overcome the abovementioned disadvantages but identifies N-(2-ethylhexyl)carbazole as new fluorescent probe. All of the characteristics necessary for the material for the plastic scintillation measurement according to the invention can thus be essentially limited to a polymeric matrix and to the primary fluorophore composed of the N-(2-ethylhexyl)carbazole molecule. This molecule fulfills the function of primary fluorophore, indeed even of secondary fluorophore: since the impact of the secondary fluorophore is thus reduced, this results in a simplification of the composition of the plastic scintillator in order to be freed from the difficulty in very precisely determining the appropriate proportion between the primary and secondary fluorophore for the purpose of obtaining a radioluminescence radiation and/or a Stokes shift which are optimized.

Furthermore, advantageously, N-(2-ethylhexyl)carbazole has a high flash point of 170° C., a good chemical stability, a high solubility and miscibility with the compounds used in the manufacture of plastic scintillators, a limited photobleaching, a moderate manufacturing cost, and no significant permeability to gases. These properties make it a particularly suitable compound for the manufacture of plastic scintillators.

At the molecular scale, the plastic scintillator of the invention can be regarded as a pseudoliquid because the chains of the polymers constituting all or a portion of the polymeric matrix are labile and allow a certain degree of movement to the different constituents of the plastic scintillator. At the macroscopic scale, the plastic scintillator nevertheless retains a mechanical strength sufficient for the purpose of manufacturing a part for scintillation detection.

The N-(2-ethylhexyl)carbazole is, for its part, in the liquid state. This has the advantage of limiting, indeed even preventing, the phase separation thereof over time and thus the aging of the plastic scintillator. Moreover, the N-(2-ethylhexyl)carbazole can consequently spontaneously form at least one exciplex, namely the association of at least two identical monomers which exists only in the excited state, and more particularly an excimer, which is an exciplex formed of only two identical monomers. The exciplex form can thus comprise several types of exciplexes which coexist, for example an exciplex with two identical monomers and an exciplex with three identical monomers.

A high concentration of N-(2-ethylhexyl)carbazole promotes the exciplex form of this molecule, with respect to the monomer form with which it is spontaneously in physicochemical equilibrium, which is then in minor concentration. For such a concentration, the maximum of the emission spectrum in fluorescence of ethylhexyl)carbazole is advantageously centered on or close to 420 nm. This wavelength is particularly suitable for the detection, by current photomultipliers, of the signal resulting from the radioluminescent radiation, which improves the sensitivity of the plastic scintillation measurement.

The primary fluorophore used in the material of the invention is composed of N-(2-ethylhexyl)carbazole, a possibly high proportion of which is in the exciplex form. Such a characteristic is unexpected from the viewpoint of the general knowledge accepted by a person skilled in the art, who considers that an exciplex can hardly emit light, which is harmful to the scintillation process: the document “M. Dalla Palma et al., Optical Materials, 2015, 42, 111-117” [3] specifies, for example, that the formation of excimer (and thus more generally of exciplex) has to be avoided as much as possible in order, among others, to promote the energy transfers necessary for a good scintillation measurement, among others transfers by Forster-type interaction.

Advantageously, despite the formation of exciplex, a high proportion of N-(2-ethylhexyl)carbazole can be employed in the material of the invention.

The invention is completed by the following subject matters and/or characteristics, taken alone or according to any one of their technically possible combinations.

In the present description of the invention, a verb such as “to comprise”, “to incorporate”, “to include” and its conjugated forms are open terms and thus do not exclude the presence of additional element(s) and/or step(s) which are added to the initial element(s) and/or step(s) stated after these terms. However, these open terms are additionally targeted at a specific embodiment in which only the initial element(s) and/or step(s), with the exclusion of any other, are targeted; in which case, the open term additionally targets the closed term “to consist of”, “to constitute”, “to compose of” and its conjugated forms.

The use of the indefinite article “a” or “an” for an element or a step does not exclude, unless otherwise mentioned, the presence of a plurality of elements or steps.

Furthermore, unless otherwise indicated:
the values at the limits are included in the ranges of parameters indicated;
the temperatures indicated are considered for an implementation at atmospheric pressure;
any percentage by weight of a component of the plastic scintillator refers to the total weight of the plastic scintillator, the remainder being constituted by the polymeric matrix.

According to a preferred embodiment, the material of the invention consists of:
a polymeric matrix;
a primary fluorophore incorporated in the polymeric matrix and composed of N-(2-ethylhexyl)carbazole, the monomer form of the N-(2-ethylhexyl)carbazole being spontaneously in physicochemical equilibrium with the exciplex form; and,
a secondary fluorophore.

The material then does not contain another component.

The polymeric matrix of the material of the invention is completely or partially composed of at least one polymer comprising repeat units resulting from the polymerization of monomers or oligomers (which can themselves originate from the polymerization of monomers). The chemical structure of the repeat units is thus similar to the chemical structure of the monomers, the latter structure having only been modified by the polymerization reaction. In the present description, a polymer is a general term which also denotes a copolymer, namely a polymer which can comprise repeat units of different chemical structure.

The monomer or oligomer comprises, for example, at least one aromatic (among others, for making use of its photophysical properties), (meth)acrylic (namely acrylic or methacrylic) or vinyl group. A polymerizable group can be a group comprising an unsaturated ethylene carbon-carbon double bond, such as, for example, the (meth)acrylic or vinyl group. In addition, this polymerizable group must be able to be polymerized according to a radical polymerization.

More specifically, at least one monomer can be chosen from styrene, vinyltoluene, vinylxylene, vinylbiphenyl, vinylnaphthalene, vinylcarbazole, methyl (meth)acrylate, (meth)acrylic acid or 2-hydroxyethyl (meth)acrylate.

Preferably, the monomer is styrene or vinyltoluene.

The polymeric matrix can be constituted, completely or partially, of at least one crosslinked polymer (for example crosslinked by means of a crosslinking agent), in order, among others, to improve the mechanical and/or scintillation properties. The crosslinking agent can be a monomer comprising at least two polymerizable functional groups capable, after polymerization, of forming a bridge between two polymer chains. It can be chosen from divinylbenzene, an alkyl diacrylate or an alkyl dimethacrylate, the hydrocarbon chain of the last two containing between 2 and 20 carbon atoms.

Preferably, the crosslinking agent is 1,4-butanediyl dimethacrylate or divinylbenzene.

After polymerization of the crosslinked polymer, apart from the abovementioned repeat units, the copolymer obtained can comprise repeat units resulting from the polymerization of the crosslinking agent.

As regards one of the other main constituents of the material of the invention, which is the primary fluorophore composed of N-(2-ethylhexyl)carbazole, the material of the invention can comprise from 1% by weight to 40% (indeed even to 50%, indeed even to 60%) by weight of the primary fluorophore, for example from 2% by weight to 45% by weight of the primary fluorophore. Above such a concentration, an exudation, namely a sweating of the primary fluorophore out of the plastic scintillator, may possibly occur.

Preferably, the material of the invention comprises from 1% by weight to 5% by weight of the primary fluorophore (preferably from 3% by weight to 5% by weight), or alternatively and preferably from 10% by weight to 50% by weight of the primary fluorophore (preferably from 30% by weight to 40% by weight).

The percentages by weight of the primary fluorophore, of the secondary fluorophore or of an additional compound can be determined a posteriori in the plastic scintillator by an analytical technique, such as, for example, solid-state Nuclear Magnetic Resonance (NMR) or mass spectrometry. Another technique consists in dissolving the plastic scintillator in dichloromethane, precipitating, from methanol, the constituent polymer of the polymeric matrix, filtering the mixture obtained, in order to recover the N-(2-ethylhexyl)carbazole when it is desired, for example, to measure the concentration of the primary fluorophore, and then quantifying the N-(2-ethylhexyl)carbazole by elemental analysis with detection of nitrogen.

Optionally, the material of the invention can contain one or more substances not having a significant impact on the plastic scintillation measurement with the material of the invention or improving some of its properties. These substances are generally dispersed more or less homogeneously in the material.

If appropriate, the material of the invention can comprise at least one additional compound, such as, for example, at least one neutron absorber. A neutron absorber has the effect of detecting thermal neutrons by radiative capture.

The plastic scintillator can thus comprise, as percentage by weight, from 0.1% to 6% of neutron absorber.

The neutron absorber generally comprises an inorganic entity. Its percentage by weight in the material can thus be measured a posteriori by elemental analysis after milling the plastic scintillator. The percentage by weight of the neutron absorber is thus expressed hereinafter by the percentage by weight of the inorganic entity (and more particularly a metal entity, such as, for example, gadolinium) in the material.

The neutron absorber generally comprises an inorganic chemical entity. It can be chosen from at least one organometallic complex, typically at least one organometallic lithium, gadolinium, boron or cadmium complex, or a mixture of these complexes, namely a mixture of complexes comprising an identical or different inorganic entity.

The organometallic lithium complex is, for example, lithium salicylate and/or lithium phenyl salicylate.

The organometallic gadolinium complex is, for example, chosen from gadolinium tris(tetramethylheptanedionate), a gadolinium tricarboxylate or gadolinium tris(acetylacetonate) (Gd(acac)₃). Its concentration in the plastic scintillator is, for example, comprised between 0.2% by weight and 2.5% by weight of gadolinium.

The organometallic boron complex is, for example, chosen from ortho-carborane, para-carborane or meta-carborane. Its concentration in the plastic scintillator is, for example, comprised between 1% by weight and 6% by weight of boron.

The polymeric matrix of the material of the invention also comprises a secondary fluorophore, generally according to a content of 0.002% by weight to 0.2% by weight of the secondary fluorophore. The secondary fluorophore further improves the detection of the radioluminescent radiation. Its presence is, however, less essential than for a plastic scintillator of the state of the art, since the material of the invention comprises N-(2-ethylhexyl)carbazole, which acts both as primary fluorophore and as secondary fluorophore.

The secondary fluorophore is, for example, chosen from 1,4-di[2-(5-phenyloxazolyl)]benzene (POPOP), 1,4-bis(2-methylstyryl)benzene (Bis-MSB), 9,10-diphenylanthracene (DPA), 1,4-bis(4-methyl-5-phenyl-2-oxazolyl)benzene (dimethylPOPOP) or their mixtures: equivalent molecules which may also be suitable as secondary fluorophore are those which have similar or identical spectroscopic properties.

The invention also relates to a part for plastic scintillation detection comprising a material as defined above according to one or more of the alternative forms described in the present description for this material, among others in one or more of the alternative forms described which relate to the composition and/or the proportion of the constituents of the material (polymeric matrix and primary fluorophore, secondary fluorophore) and of any substance which the material may optionally contain (neutron absorber, and the like).

This part can be a unit (such as, for example, a detector) or a subunit (such as, for example, an optical fiber) of a structure intended for plastic scintillation detection.

For example, the part is constituted by a walk-through scanner, a CCD (Charge Coupled Device) detector or an optical fiber.

The invention also relates to a device for plastic scintillation measurement comprising a part as defined above according to one or more of the alternative forms described in the present description. For example, the device is constituted by a portable instrument for the measurement of ionizing radiation, which can optionally comprise a CCD detector or an optical fiber.

The invention also relates to a process for the manufacture of the material of the invention as defined in the present description, among others according to one or more of the alternative forms described for this material as indicated above.

The manufacturing process comprises the following steps:

a) having available a polymerization medium comprising:
monomers, oligomers or their mixtures intended to form at least one constituent polymer of a polymeric matrix;
a primary fluorophore composed of ethylhexyl) carbazole; and,
a secondary fluorophore;

b) polymerizing the polymerization medium in order to obtain the material.

During step b) of polymerization of a precursor of the polymer (namely the abovementioned monomers and/or oligomers), the primary fluorophore and the secondary fluorophore are trapped and distributed more or less homogeneously in the polymeric matrix being formed.

The polymerization medium can comprise at least one other entity incorporated in the material and targeted at conferring specific properties on it; in particular a neutron absorber, an additional secondary fluorophore, a crosslinking agent, a polymerization initiator or their mixtures.

Preferably, the polymerization medium can comprise from 0.001% by weight to 1% by weight of polymerization initiator.

The polymerization reaction according to step b) can be carried out according to the conditions ordinarily employed by a person skilled in the art.

For example, as indicated in the patent application WO 2013076281 [4], the polymerization initiator can be chosen from a peroxide compound (for example benzoyl peroxide), a nitrile compound (for example azobisisobutyronitrile) or their mixtures. When the polymerization reaction is carried out with methacrylate monomers, it can be induced by heating the polymerization medium to a suitable temperature (generally comprised between 20° C. and 140° C.), or by doping the polymerization medium with 2,2-dimethoxy-2-phenylacetophenone as polymerization initiator and by then carrying out irradiation under UV (for example at a wavelength of 355 nm). The polymerization reaction in the presence of styrene monomers can be induced thermally, typically by heating between 20° C. and 140° C.

Stages a) and b) of the manufacturing process of the invention can be carried out in a mold in order to obtain a part as defined above or a preform of this part.

The manufacturing process of the invention can also comprise a step c) during which the material is machined in order to obtain the part as defined above.

The manufacturing process can comprise a step c) during which the material or the preform of the part is machined in order to obtain the part as defined above. This machining step consists, for example, in precision grinding the faces on a lathe and in then polishing them.

The invention also relates to a material obtained or obtainable by the manufacturing process as defined in the present description, among others according to one or more of the alternative forms described above for this material.

The invention also relates to the use of N-(2-ethylhexyl)carbazole for detection in plastic scintillation, and more specifically to a plastic scintillation measurement process using the material of the invention as defined in the present description, among others according to one or more of the alternative forms described for this material as indicated above.

The measurement process comprises the following steps:

i) at least one material as defined above is brought into contact with ionizing radiation or an ionizing particle in order for the material to emit radioluminescent radiation; and

ii) the radioluminescent radiation is measured.

The ionizing radiation or the ionizing particle originates from a radioactive substance which emits gamma rays, X-rays, beta particles, alpha particles or neutron. If appropriate, the radioactive substance can emit several types of ionizing radiation or of ionizing particles.

The radioluminescent radiation which results from this exposure can be measured according to step ii) with a photodetector, such as, for example, a photodetector chosen from a photomultiplier, a Charge-Coupled Device (CCD) camera, a CMOS (for Complementary Metal-Oxide Semiconductor) sensor, or any other photon detector, the capture of which photon is converted into an electric signal.

According to a preferred embodiment of the invention, the measurement process can comprise a step iii) in which the presence and/or the amount of the radioactive substance is determined from the measurement of the radioluminescent radiation according to step ii), as is ordinarily carried out in plastic scintillation. By way of example, step iii) of qualitative and/or quantitative measurement is described by analogy with the plastic scintillation starting from the document “Techniques de l'ingénieur, Mesures de radioactivité par scintillation liquide, Référence p 2552, publication du 10/03/2004” [Techniques of the Engineer, Measurements of radioactivity by liquid scintillation, Reference p 2552, publication of Oct. 3, 2004] [5].

The quantitative determination can, among others, measure the activity of the radioactive source. It can be carried out starting from a calibration curve.

This curve is, for example, such that the number of photons originating from the radioluminescent radiation emitted for a known radioactive substance is correlated with the energy of the incident radiation for this radioactive substance. It is then possible, from the solid angle, the distance between the radioactive source and the plastic scintillator, and the activity detected by the measurement process using the plastic scintillator of the invention, to quantify the activity of the radioactive source.

Other subject matters, characteristics and advantages of the invention will now be specified in the description which follows of specific embodiments of the invention, given by way of illustration and without limitation, with reference to the appended FIGS. 1 to 4.

The absorption spectra are measured with a UV/visible spectrophotometer.

The fluorescence emission spectra are produced with a spectrofluorometer.

The N-(2-ethylhexyl)carbazole molecule is denoted hereinafter under the abbreviation “EHCz”.

### BRIEF DESCRIPTION OF THE FIGURES

FIG. 1 represents the light absorption spectra of plastic scintillators according to the invention. The absorbance, expressed in an arbitrary unit, is a function of the wavelength of the light absorbed, expressed in nanometers.

FIG. 2 represents the fluorescence emission spectrum of plastic scintillators according to the invention. The intensity, expressed in a standardized unit, is a function of the wavelength of the light emitted, expressed in nanometers.

FIG. 3 represents the light yield of plastic scintillators according to the invention comprising an increasing concentration of EHCz. The light yield, expressed in an arbitrary unit, is a function of the percentage by weight of the EHCz molecule in each plastic scintillator.

FIG. 4 represents the energy spectra of three plastic scintillators when the EHCz is used alone at the concentration of 3 molar %, mixed in addition with the secondary fluorophore POPOP and mixed with the secondary fluorophore Bis-MSB. The light yield obtained on the ordinate is expressed in an arbitrary unit.

### DESCRIPTION OF SPECIFIC EMBODIMENTS

The examples are carried out at atmospheric pressure and ambient temperature.

### 1. Synthesis of the EHCz Molecule

The EHCz molecule is available commercially under the CAS registry number 187148-77-2.

It can be obtained by nucleophilic reaction of carbazole, deprotonated beforehand, with 2-ethylhexyl bromide, according to the following reaction scheme:

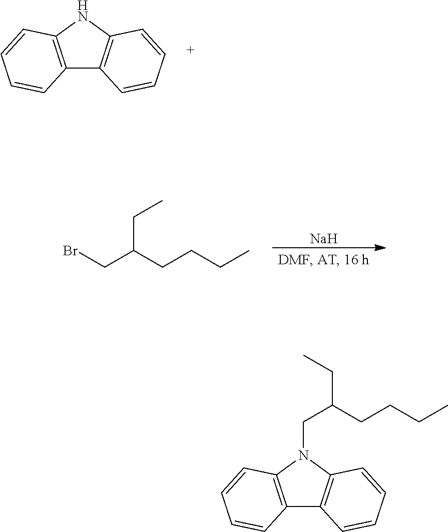

The carbazole is added portionwise to a suspension of sodium hydride, cleaned beforehand with pentane of its mineral oil, in dry N,N-dimethylformamide (DMF) in a 500 ml round-bottomed flask maintained under an argon atmosphere. After stirring for 30 minutes, the 2-ethylhexyl bromide is slowly added.

The mixture obtained is stirred at ambient temperature for 16 hours.

Water is added to the mixture and then the crude product is extracted with ethyl ether. The organic phase is dried, concentrated and then purified by chromatography on silica gel.

The EHCz molecule obtained is a colorless oil. The molar yield is approximately 73% for 20 g of EHCz synthesized.

The characteristics of the proton NMR spectrum of the EHCz molecule are as follows: ¹H NMR (CDCl₃, 500 MHz) δ 0.86 (t, 3H, ³J 7.3); 0.91 (t, 3H, ³J 7.3); 1.21-1.43 (m, 8H); 2.07 (sep, 1H, ³J 6.7); 4.10-4.21 (m, 2H); 7.39 (d, 4H, ³J 8.2); 7.45 (dt, 4H, ³J 6.9, ⁴J 1.1).

### 2. Physicochemical Characteristics of the EHCz Molecule

In its pure form, the properties of EHCz are as follows:
colorless transparent liquid;
refractive index of 1.64 at 404 nm;
fluorescence centered at approximately 420 nm;
high flash point of 170° C.;
viscous liquid state at ambient temperature;
good stability with regard to temperature, time and oxygen.

### 3. Manufacture of Plastic Scintillators

Different plastic scintillators are manufactured according to the characteristics specified in Table 1: they differ in the EHCz content and the composition of the polymeric matrix, which can comprise styrene (“St”) and/or 1,4-butanediyl dimethacrylate (“1,4”) (with indication of the proportion by weight of each monomer when they are both present in the matrix), and also in the possible presence of a secondary fluorophore, such as 1,4-bis[2-(5-phenyloxazolyl)]benzene (POPOP) or 1,4-bis(2-methylstyryl)benzene (Bis-MSB), which are represented below. The EHCz content and the secondary fluorophore content are expressed as percentage by weight of the plastic scintillator, the remainder being constituted by the percentage by weight of the polymeric matrix.

TABLE 1

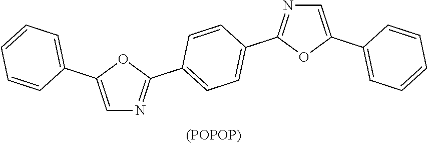

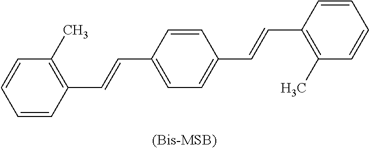 [SMILES: Cc1ccccc1/C=C/c1ccc(/C=C/c2ccccc2C)cc1]

| | Composition of the | | |
|---|---|---|---|
| | matrix (proportion by | | |
| | weight in the case of a | EHCz | Secondary |
| | mixture) [% by weight | (% by | fluorophore |
| # | of the mixture] | weight) | (% by weight) |
| 1 | St/1, 4 (80:20) [99] | 1 | |
| 2 | St/1, 4 (80:20) [98] | 2 | |
| 3 | St/1, 4 (80:20) [97] | 3 | |
| 4 | St/1, 4 (80:20) [96] | 4 | |
| 5 | St/1, 4 (80:20) [95] | 5 | |
| 6 | St/1, 4 (80:20) [96.97] | 3 | POPOP (0.03) |
| 7 | St/1, 4 (80:20) [96.97] | 3 | Bis-MSB (0.03) |
| 8 | St [90] | 10 | |
| 9 | St [80] | 20 | |
| 10 | St/1, 4 (80:20) [70] | 30 | |
| 11 | St/1, 4 (80:20) [60] | 40 | |

By way of representative example for all the plastic scintillators of Table 1, the manufacture of the reference plastic scintillators 10 and 7 is described in detail hereinafter.

### 3.1. Example 1 of Manufacture of a Plastic Scintillator Devoid of Secondary Fluorophore (Reference 10)

A mixture composed of purified EHCz (20% by weight) and distilled styrene (80% by weight) is introduced under an inert atmosphere composed of argon into a round-bottomed flask predried under vacuum. The mixture is degassed according to the freeze-pump-thaw degassing method. Having returned to ambient temperature, the solution is poured into a mold intended to give the form of the scintillator. This mold is sealed under an inert atmosphere and then heated at 65° C. for 10 days. Once the polymerization is complete, the mold is broken in order to recover the crude plastic scintillator, which is polished to give it its final form.

### 3.2. Example 2 of Manufacture of a Plastic Scintillator Comprising a Secondary Fluorophore (Reference 7)

A mixture composed of purified EHCz (3% by weight), POPOP (0.03% by weight), styrene (77.58% by weight) and 1,4-butanediyl dimethacrylate (19.39% by weight) is introduced under an inert atmosphere composed of argon into a round-bottomed flask predried under vacuum. The mixture is degassed according to the freeze-pump-thaw degassing method. Having returned to ambient temperature, the solution obtained is poured into a mold intended to give the form of the plastic scintillator. This mold is sealed under an inert atmosphere and then heated at 65° C. for 10 days. Once the polymerization is complete, the mold is broken in order to recover the crude plastic scintillator, which is polished to give it its final form.

### 4. Photophysical Properties of a Plastic Scintillator Comprising the EHCz Molecule

### 4.1. Properties in the Absence of Irradiation

FIG. 1 shows the absorption spectra of the reference plastic scintillator 8 having 10% by weight of EHCz (continuous line) and the reference plastic scintillator 9 having 20% by weight of EHCz (dotted line). It shows the advantage of incorporating EHCz at a high concentration in order for the exciplex formed to emit as far as possible luminescence in the region of transparency of the material.

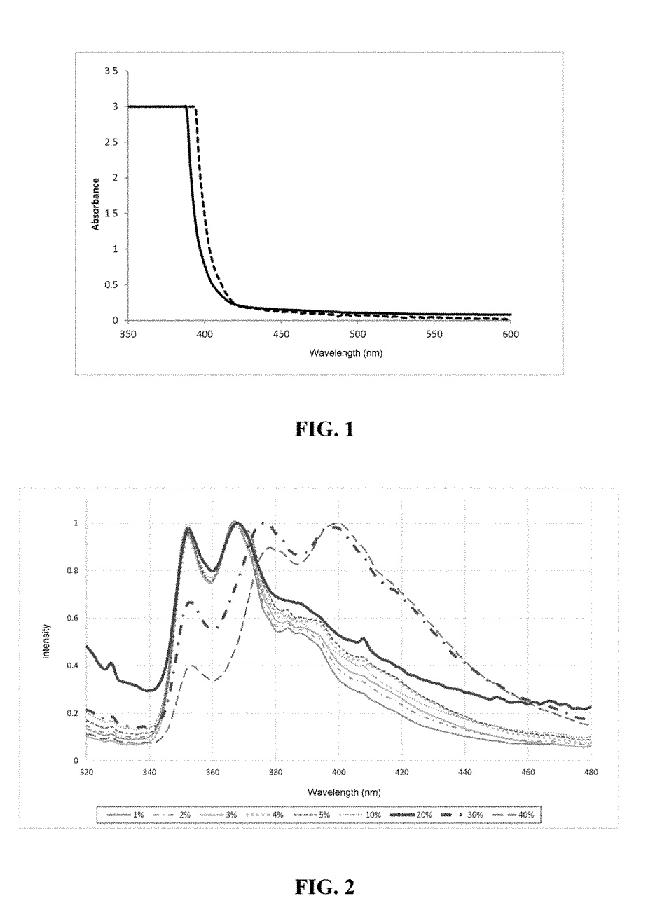

FIG. 2 shows the fluorescence emission spectra of the plastic scintillators 1 to 5 and 8 to 11. In order to make it easier to compare them, the intensity of these spectra is standardized by arbitrarily assigning the value 1 to the value of greatest intensity of each spectrum.

FIG. 2 illustrates the fact that the fluorescence emission spectrum is shifted toward the higher wavelengths when the EHCz concentration increases in the plastic scintillator: this hypsochromic shift reflects the increase in the concentration of EHCz molecules in the exciplex form to the detriment of the monomer form with which it is in physicochemical equilibrium. The proportion of the excimer form becomes particularly high, in particular for concentrations of EHCz of greater than 30%.

### 4.2. Properties Under Irradiation by a Gamma Source

In an environment protected from light, the plastic scintillators 1 to 5 and 8 to 11 are successively coupled optically using a Rhodorsil optical grease to a photomultiplier supplied with high voltage. A cobalt-60 gamma source irradiates each plastic scintillator, which then emits scintillation photons. An electronic acquisition device converts the scintillation pulse into an electronic signal which is subsequently amplified by a photomultiplier and then recorded and digitized by virtue of an electronic acquisition board.

The signal obtained is subjected to the following processing sequence: inversion of the signal in order to render it positive, smoothing, integration of the signal with respect to time, distribution of the value by histogram, followed by subtraction of the signal obtained under the same conditions without plastic scintillator in order to eliminate the residual background noise.

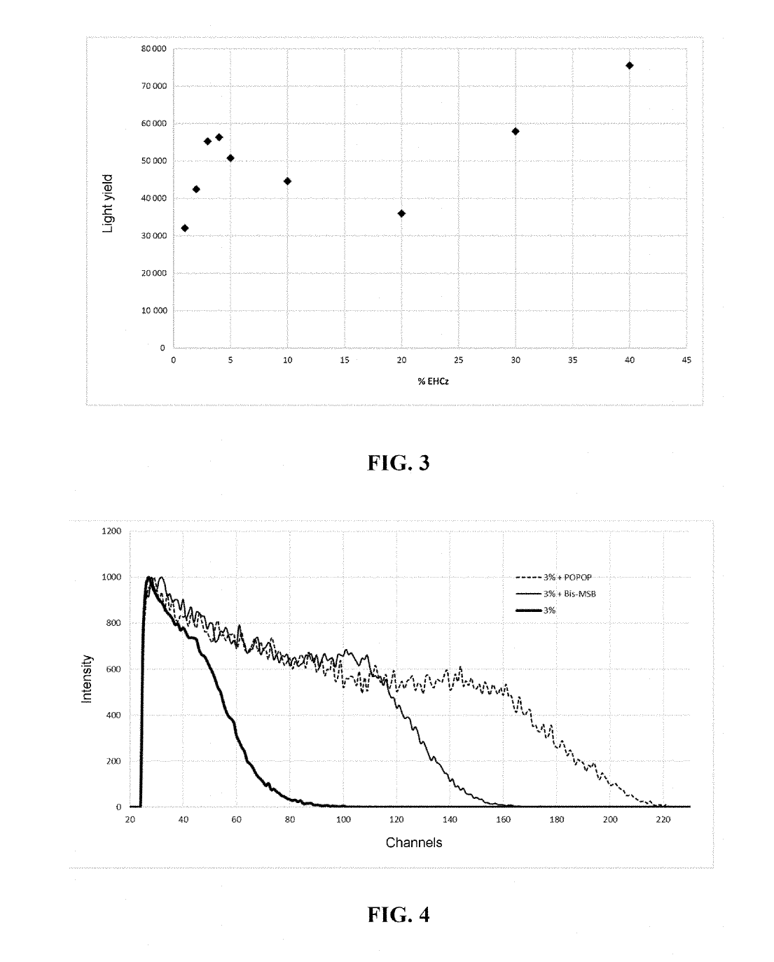

This histogram makes it possible to obtain an energy spectrum, which then gives the light yield obtained for each plastic scintillator, as illustrated by FIG. 3.

This figure shows that, for EHCz concentrations of less than 20%, there exists an optimum light yield centered at 4%. Beyond approximately 20%, the light yield again increases because the response of the plastic scintillator is shifted toward the high wavelengths by virtue of the higher concentration of the excimer form of the EHCz.

### 5. Influence of the Presence of a Secondary Fluorophore in the Plastic Scintillator of the Invention

The plastic scintillators 6 and 7, respectively comprising POPOP and Bis-MSB as secondary fluorophore, are compared with the plastic scintillator 3 comprising the same proportion of EHCz (3% by weight). The energy spectrum histograms obtained according to the protocol described in example 6 are illustrated by FIG. 4. This figure shows that the EHCz can behave as a primary fluorophore suited to the scintillation. Moreover, if no secondary fluorophore is added to the plastic scintillator, the weak pulses obtained are reflected by a squashing of the spectrum towards the left which corresponds to the low output energies, indicating that the plastic scintillator is not luminous enough. This is explained by the fact that the emission wavelength for 3% by weight of EHCz is not the most suitable for the photomultiplier used and that the plastic scintillator absorbs a portion of the light which it emits.

The presence of a secondary fluorophore in the material for the plastic scintillation measurement according to the invention is generally particularly advantageous for the purpose of improving the quality of the measurement. The percentage by weight of EHCz in the plastic scintillator can then preferably be comprised between 0.002% and 0.2%, indeed even between 0.01% and 0.1%.

### 6. Example of Qualitative or Quantitative Plastic Scintillation Measurement of a Radioactive Substance According to the Measurement Process of the Invention

### 6.1. Measurement Protocol

A plastic scintillator comprising EHCz and a secondary fluorophore is connected to a photomultiplier tube by means of optical grease.

Subsequent to its exposure to the radioactive substance, the plastic scintillator emits scintillation photons which are converted into an electrical signal by the photomultiplier tube supplied with high voltage.

The electrical signal is subsequently acquired and then analyzed with an oscilloscope, spectrometry software or an electronic acquisition board.

This analysis results in an energy spectrum histogram representing, on the abscissa, the channels (derived from an output energy) and, on the ordinate, the number of counts. After calibration with a gamma-emitting source of known energy, the energy of the radioactive substance to be measured is determined.

### 6.2. Quantitative Measurement with the Plastic Scintillator 5

On the basis of this measurement protocol, a quantitative measurement is carried out with the reference plastic scintillator 5 of Table 1 containing 5% by weight of the EHCz molecule and manufactured according to the manufacturing process described in detail in example 3.

The plastic scintillator is coupled using the Rhodorsil RTV141A optical grease to a photomultiplier (Hamamatsu H1949-51 model) supplied with a high voltage (Ortec 556 model). The signal leaving the photomultiplier is recovered and then digitized by an electronic board specific to the inventors. This board can be replaced by another equivalent electronic board (for example CAEN DT5730B model) or an oscilloscope (for example Lecroy Waverunner 640Zi model).

In a first step, an energy calibration of the system (scintillator+photomultiplier) is carried out by means of 2 radioactive sources: one emitting gamma rays in the [0-200 keV] range and the other in the [500-1.3 MeV] range. This energy calibration is carried out by locating the channel corresponding to 80% of the amplitude of the Compton edge. For example, if the ordinate of the Compton edge corresponds to 100 counts, the abscissa on the falling slope of the Compton edge at 80 counts associates the energy of the Compton edge (in keV) with the channel.

In a second step, this calibration having been carried out, a chlorine-36 beta source (mean energy 251 keV, 2n activity equal at most to 3 kBq) is joined to the upper face of the plastic scintillator. The analysis of the energy spectrum gives a read activity of 2.1 kBq (and thus an intrinsic efficiency of 70%) and a photoelectric peak centered at approximately 250 keV.

### 6.3. Quantitative Measurement with the Plastic Scintillator 7

On the basis of the same measurement protocol, a quantitative measurement is carried out with the reference plastic scintillator 7 of Table 1 containing 3% by weight of the EHCz molecule and 0.03% by weight of the Bis-MSB molecule and manufactured according to the manufacturing process described in detail in example 3.

The plastic scintillator is coupled using the Rhodorsil RTV141A optical grease to a photomultiplier (Hamamatsu H11284 MOD model) supplied with a high voltage (CAEN N1470 model).

The recovery and then the digitization of the signal leaving the photomultiplier, and also the energy calibration of the system, is in accordance with example 6.2.

This calibration having been carried out, a chlorine-36 beta source (mean energy 251 keV, 2n activity equal at most to 3 kBq) is joined to the upper face of the plastic scintillator. The analysis of the energy spectrum gives a read activity of 2.8 kBq (and thus an intrinsic efficiency of 96%) and a photoelectric peak centered at approximately 250 keV.

The present invention is not limited to the embodiments described and represented, and a person skilled in the art will know how to combine them and to contribute thereto with his general knowledge of numerous alternative forms and modifications.

The invention is applicable to the fields where scintillators are used, in particular:
in the industrial field, for example for the measurement of physical parameters of parts during manufacture, for the nondestructive inspection of materials, for the monitoring of radioactivity at the entrance and exit points of sites and for the monitoring of radioactive waste,
in the geophysical field, for example for the evaluation of the natural radioactivity of soils,
in the field of fundamental physics and in particular nuclear physics,
in the field of the safety of goods and people, for example for the safety of critical infrastructures, the monitoring of moving goods (luggage, containers, vehicles, and the like), and also for the protection from radiation of workers in the industrial, nuclear and medical sectors,
in the field of medical imaging.

### REFERENCES CITED

[1] Principles and practice of plastic scintillator design, Radiat. Phys. Chem., 1993, Vol. 41, No. 1/2, 31-36.
[2] Current status on plastic scintillators modifications, Chem. Eur. J., 2014, 20, 15660-15685.
[3] Non-toxic liquid scintillators with high light output based on phenyl-substituted siloxanes, Opt. Mater., 2015, 42, 111-117.
[4] WO 2013076281.
[5] Techniques de l'ingénieur, Mesures de radioactivité par scintillation liquide, Référence p2552, publication du 10/03/2004 [Techniques of the Engineer, Measurements of radioactivity by liquid scintillation, Reference p 2552, publication of Oct. 3, 2004].

1. A composition for plastic scintillation measurement, comprising:
a polymeric matrix;
a primary fluorophore incorporated in the polymeric matrix and composed of N-(2-ethylhexyl)carbazole, the monomer form of the N-(2-ethylhexyl)carbazole being spontaneously in physicochemical equilibrium with the exciplex form; and,
a secondary fluorophore.

2. A composition according to claim 1, wherein the polymeric matrix is completely or partially composed of at least one polymer comprising repeat units resulting from the polymerization of a monomer comprising at least one aromatic, (meth)acrylic or vinyl group.

3. A composition according to claim 2, wherein the monomer is at least one monomer selected from the group consisting of styrene, vinyltoluene, vinylxylene, vinylbiphenyl, vinylnaphthalene, vinylcarbazole, methyl (meth)acrylate, (meth)acrylic acid and 2-hydroxyethyl (meth)acrylate.

4. A composition according to claim 3, wherein the monomer is styrene or vinyltoluene.

5. A composition according to claim 1, wherein the polymeric matrix is constituted, completely or partially, of at least one crosslinked polymer.

6. A composition according to claim 1, wherein the composition comprises from 1% by weight to 50% by weight of the primary fluorophore.

7. A composition according to claim 6, wherein the composition comprises from 1% by weight to 5% by weight of the primary fluorophore.

8. A composition according to claim 6, wherein the composition comprises from 10% by weight to 50% by weight of the primary fluorophore.

9. A composition according to claim 1, wherein the composition comprises at least one neutron absorber.

10. A composition according to claim 9, wherein the neutron absorber is selected from the group consisting of at least one organometallic lithium, boron, gadolinium or cadmium complex and a mixture of these complexes.

11. A composition according to claim 10, wherein the neutron absorber is an organometallic gadolinium complex selected from the group consisting of gadolinium tris(tetramethylheptanedionate), a gadolinium tricarboxylate and gadolinium tris(acetylacetonate).

12. A composition according to claim 10, wherein the neutron absorber is an organometallic gadolinium complex present in the material at a concentration between 0.2% by weight and 2.5% by weight of gadolinium.

13. A composition according to claim 12, wherein the polymeric matrix comprises from 0.002% by weight to 0.2% by weight of the secondary fluorophore.

14. A composition according to claim 12, wherein the secondary fluorophore is selected from the group consisting of 1,4-di[2-(5-phenyloxazolyl)]benzene, 1,4-bis(2-methylstyryl)benzene, 1,4-bis(4-methyl-5-phenyl-2-oxazolyl)benzene, 9,10-diphenylanthracene and their mixtures.

15-16. (canceled)

17. A device for plastic scintillation detection comprising a part comprising a composition as defined by claim 1.

18. (canceled)

19. A process for the manufacture of the composition as defined by claim 1, the process comprising the following steps:
a) having available a polymerization medium comprising:
monomers, oligomers or their mixtures intended to form at least one constituent polymer of a polymeric matrix;
a primary fluorophore composed of N-(2-ethylhexyl)carbazole; and,
a secondary fluorophore;
b) polymerizing the polymerization medium in order to obtain the material.

20. A process according to claim 19, wherein the polymerization medium comprises a neutron absorber, a crosslinking agent, a polymerization initiator or their mixtures.

21. (canceled)

22. A process according to claim 19, wherein steps a) and b) are carried out in a mold.

23. A process according to claim 19, comprising a step c) during which the composition or the preform of the part is machined.

24. A plastic scintillation measurement process, comprising:
i) at least one composition as defined claim 1 is brought into contact with ionizing radiation or an ionizing particle in order for the material to emit radioluminescent radiation; and
ii) the radioluminescent radiation is measured.

25-26. (canceled)
